(19) United States
(12) Patent Application Publication
(10) Pub. No.: US 2024/0279827 A1
(43) Pub. Date: Aug. 22, 2024

(54) Electrode plate for an electrolysis system

(71) Applicant: Schaeffler Technologies AG & Co. KG, Herzogenaurach (DE)

(72) Inventors: Marcel Ehmann, Erlangen (DE); Benedikt Wehner, Fladungen (DE); Ramon Jurjanz, Buttenheim (DE); Torsten Keller, Heßdorf (DE)

(21) Appl. No.: 18/571,125

(22) PCT Filed: May 20, 2022
(86) PCT No.: PCT/DE2022/100387

§ 371 Date: Dec. 15, 2023

(30) Foreign Application Priority Data
Jun. 16, 2021 (DE) 10 2021 115 582.7
May 19, 2022 (DE) 10 2022 112 593.9

(51) Int. Cl. C25B 11/036; C25B 1/04

(52) U.S. Cl. CPC C25B 11/036; C25B 1/04

(57) ABSTRACT

An electrode plate (1) for an electrolysis system (10), said electrode plate being made of sheet metal, in particular for producing hydrogen, has an active field (3) and a frame region (2) surrounding the active field, said frame region having a basic rectangular shape. The frame region (2) is formed on a base plane (E) of the undeformed sheet metal. The active field (3) has an embossed structure (6) in the form of individual embossed elements (14, 15, 16, 17) which are raised and recessed starting from the base plane (E), including a plurality of linear embossed strips (14, 15), which are positioned in an arrangement of rows and columns such that raised linear embossed strips (14) and recessed linear embossed strips (15) are formed in an alternating manner in the direction of the rows as well as in the direction of the columns, wherein all of the linear embossed strips (14, 15) of one row are inclined in an identical manner with respect to the longitudinal side of the active field (3) and a flow direction (DR) which is parallel thereto, and the linear embossed strips (14, 15) of the following row have an equal and opposite inclination.

### CROSS-REFERENCE TO RELATED APPLICATIONS

The present application is the U.S. National Phase of PCT Patent Application Number PCT/DE2022/100387, filed on May 20, 2022, which claims priority to German Patent Application Serial Number 10 2021 115 582.7, filed on Jun. 16, 2021, and German Patent Application Serial Number 10 2022 112 593.9, filed May 19, 2022, the entire disclosures of which are incorporated by reference herein.

### FIELD OF INVENTION

The disclosure relates to an electrode plate intended for use in an electrolysis system. Furthermore, the disclosure relates to a method for producing an electrode plate for an electrolysis system, in particular for the production of hydrogen.

### BACKGROUND

An apparatus for generating hydrogen by means of electrolysis is described, for example, in EP 2 507 410 B1. The electrolysis system described is supposed to be suitable for being operated with water taken from a salt, brackish or fresh water source. The water is supplied to a carrier gas stream such that at least some of the water in evaporated form is absorbed in the carrier gas stream. The carrier gas stream loaded in this way is finally supplied to an electrolyzer.

EP 1 587 760 B1 discloses an electrolysis cell which comprises a plurality of electrolysis plates. The electrolysis plates are fastened to groove devices within a housing. The housing of the known electrolysis cell has an inlet and an outlet to allow a fluid to flow through. A plurality of plates are arranged in a stacked form in the housing.

An electrolysis plate described in DE 199 56 787 A1 consists of an outer, non-conductive frame and an electrically conductive, bipolar graphite plate mounted therein. Plastic aprons are provided for forcibly guiding electrolyte solutions in the region of an electrolyte supply.

An arrangement of electrochemical cells known from DE 10 2013 225 159 B4, which is provided, for example, for the passage of water or aqueous electrolytes, comprises basic elements in the form of flat structures that have a network structure or are formed from a porous material. A plurality of basic elements are arranged one on top of the other, with edge regions of the basic elements being connected in a fluid-tight manner with the aid of a filler.

Various electrochemical systems described in documents WO 2019/121947 A1 and WO 2020/030644 A1 each have arrangements of a plurality of separator plates, which delimit fluid spaces. The electrochemical systems described can be fuel cells or electrolysis cells.

EP 3 725 916 A1 discloses an electrolysis plate which is intended for use in an apparatus for generating hydrogen and which has an opening for the passage of gas, wherein edges of the opening are covered with an electrically non-conductive material.

A bipolar electrical vessel is known from EP 3 575 442 A1, which is provided for the production of hydrogen. The anode and/or cathode of the vessel is designed as a porous electrode. A membrane of the bipolar vessel is a porous membrane having inorganic components. The apparatus according to EP 3 575 442 A1 is supposed to be suitable for alkaline electrolysis.

Methods for incorporating hydrogen electrolysis systems into more comprehensive systems in which an energy and/or media flow takes place are described, for example, in documents WO 2014/144556 A1 and DE 20 2011 102 525 U1.

### SUMMARY OF THE INVENTION

The disclosure is based on the object of further developing the production of electrolysis plates in the form of the electrode plates relative to the prior art, with production-related as well as electrotechnical and fluidic aspects being taken into account.

This object is achieved according to the disclosure by an electrode plate having the features described in the claims. The object is also achieved by a method for producing an electrode plate according to the claims. The embodiments and advantages of the disclosure explained below in connection with the production method also apply, mutatis mutandis, to the apparatus, i.e., the electrode plate to be used in an electrolyzer, and vice versa.

The electrode plate has a frame region that surrounds an active field on which electrochemical reactions take place in the finished system, i.e. in the electrolyzer. The active field is structured in three dimensions. In typical embodiments, this does not apply to the frame region. This is flat and is formed by undeformed, flat sheet metal, which forms a base plane. The active field, like the frame region and thus the entire the electrode plate, has a rectangular, typically not square, basic shape. A plurality of the electrode plates are provided so as to be assembled into a stack of electrolysis cells.

In the active field there is an embossed structure in the form of individual embossed elements that are raised and recessed starting from the base plane, including a plurality of linear, i.e. straight, embossed strips. The linear embossed strips are positioned in an arrangement of rows and columns in such a way that raised and recessed linear embossed strips are formed in an alternating manner both in the direction of the rows and the direction of the columns, with all linear embossed strips of a row being inclined in an identical manner relative to the longitudinal sides of the active field and to a flow direction for fluids parallel thereto, and the linear embossed strips of the next row have the equal and opposite inclination. The embossed strips contribute both to the mechanical stability of the electrode plate and to the flow conduction. They also allow electrical currents to be conducted via the sheet metal used. The arrangement of the linear embossed strips, which takes place in a herringbone pattern, enables a particularly uniform flow and fluid distribution with respect to the fluids flowing past in the region of the surface of the electrode plate. Furthermore, the forming of the sheet metal from the base plane in both directions perpendicular to the base plane results in an enormous gain in the mechanical stability of the electrode plate, which allows the use of particularly thin metal sheets, particularly in the range from 150 μm to 500 μm.

Further components of the electrolysis cells, for example gas diffusion layers, can adjoin the linear embossed strips of the electrode plate. The boundary regions between the elongated linear embossed strips and the other components are flat, which is advantageous both with respect to mechanical loads and with respect to the flow of electrical charges. This is particularly relevant in large-scale electrolysis systems for the production of hydrogen.

According to an embodiment that is advantageous in terms of production technology, a sub-cluster of the embossed structure is formed in each case by two rows of linear embossed strips, with a total of at least four such sub-clusters being connected in series, for example. The series connection refers to the flow direction of the fluid or electrolyte, which in a typical embodiment corresponds to the longitudinal direction of the electrode plate. Variants can also be implemented in which a sub-cluster is made up of more than two rows of linear embossed strips. In any case, the distance between two sub-clusters can correspond, for example, to at least 5% and at most 10% of the projected length, to be measured in the longitudinal direction of the electrode plate, of the linear embossed strips arranged in a row.

The embossed elements, which in addition to linear embossed strips can also constitute embossed points, have comparatively small dimensions compared to the length and width of the active field in numerous possible designs of the electrode plate made of sheet metal, for example stainless steel or titanium. For example, at least three raised and at least three recessed embossed elements, in particular linear embossed strips, are arranged in each row.

In the inlet and/or outlet region of the fluid or electrolyte, i.e. in the first and last row of the embossed structure, the raised linear embossed strips can have the full length, which is also the case for the linear embossed strips of the remaining rows, whereas the recessed linear embossed strips are designed as greatly shortened, in particular at most half as long, linear embossed strips, with the shortening of the recessed linear embossed strips being towards the edge of the embossed structure. In a corresponding manner, it is possible to shorten the raised linear embossed strips on the input-side and/or output-side edge of the embossed structure, while the recessed linear embossed strips are in an unshortened form. The one-sided shortening of the linear embossed strips can in any case be used to bring a component of the electrolysis stack, for example a frame or a seal, into surface contact with the electrode plate.

According to a possible further development, the height of the raised linear embossed strips differs from the height of the recessed linear embossed strips, with the appearance of a linear embossed strip as “raised” or “recessed” always depending on which side of the metal sheet the linear embossed strip is viewed from. Instead of “height of the embossed strips”, the term “embossed depth” is also used. The embossed depth must be measured orthogonally to the base plane of the undeformed metal sheet. The different embossed depths on one and the other side of the metal sheet result in an asymmetry of the embossed structure. This asymmetry can be used to specifically set different flow conditions on the cathodic and anodic sides of the electrode plate. In particular, the difference between the embossed depth given on the cathodic side and the embossed depth given on the anodic side is more than the sheet thickness of the metal sheet to be measured from the base plane of the metal sheet.

In general, the electrode plate can be produced efficiently by forming processes by producing a plurality of individual embossed elements which protrude different distances from the surfaces of the undeformed metal sheet on both sides of the electrode plate and together describe a herringbone pattern on each side of the electrode plate.

The electrode plate, including the structure in the form of a herringbone pattern, can be provided with a single-layer or multi-layer coating. The entire electrode plate is not necessarily coated in a uniform manner. In particular, a coating can only be present in the active field, but not in the frame region. It is also possible to coat the frame region in a way that differs from the active field.

In all of the embodiments, an advantage of the electrode plate is, in particular, that a three-dimensional, double-sided design supports a laminar media flow that is uniformly distributed over the active field. The elevations and recesses in the active field, provided they do not merely protrude from the surface in a punctiform manner, can be based on a sinusoidal shape in a greatly modified manner. In contrast to a sinusoidal profile, there can be plateaus in particular which lie in planes that are at a maximum distance from the surface of the undeformed metal sheet. This applies to both the longitudinal section and the cross section through a linear embossed strip. In both cases, the flanks of the linear embossed strips are inclined, for example, at an angle of 30° to 60° with respect to the plane in which the surface of the metal sheet lies that is not or not significantly deformed, as a result of which there can be a trapezoidal shape in section in the longitudinal and transverse directions.

In a plan view of the electrode plate, the individual linear embossed strips can, for example, be inclined at an angle of 45°±15° which is uniform in magnitude with respect to the longitudinal sides of the electrode plate. Together with the described longitudinal section and transverse section shape, this results in a flow-guiding effect that is designed to avoid dead spaces during operation of the electrolyzer, with the formation of stationary vortices in recesses in particular being minimized.

According to a modified embodiment, the arrangement, in particular herringbone-like arrangement, of the linear embossed strips placed obliquely with respect to the flow direction of the fluid or electrolyte is flanked by two rows of embossed elements, for example embossed points, which are disposed on the longitudinal sides of the active field and which are oriented in the direction of the columns of the embossed structure. These embossed elements, which are small in comparison with the linear embossed strips and are in particular almost punctiform embossed elements, and which are each disposed in a strip at the edge of the active field, i.e. at the transition to the frame region, have the effect that the flow eases in the relevant narrow regions. In particular, flow components are dampened orthogonally to the longitudinal direction of the electrode plate compared to the center of the active field.

Instead of punctiform elevations, embossed elements can also be present in the lateral regions of the active field, which extend from the inflow region to the outflow region of the fluid or electrolyte, each of which embossed elements describes a V-shape, with such a V-shaped embossed element being disposed at the beginning and end of each row of linear embossed strips. Here, the V-sides of the embossed elements are directed towards the linear embossed strips lined up in a row. This means that each row of inclined linear embossed strips is enclosed by two V-shaped embossed elements in the manner of an “open angle bracket” symbol and a “closed angle bracket” symbol. The V-shaped embossed elements, which appear as angle brackets, can be dimensioned in such a way that they are only partially covered by a component of the electrolysis stack resting on the electrode plate. The component by which a frame step can be formed is disposed outside the active surface, with the channel-like recesses, which are in the form of the V-legs, protruding from the covering, while the central bend of each V-shaped embossed element is disposed below the covering. This configuration achieves two advantages: On the one hand, a non-functional media flow at the edge of the active field is largely prevented; on the other hand, a small flow of media is permitted through the channels formed by the V-shaped embossed elements, which prevents the accumulation of fluids in dead spaces.

In the entire active field, the structure of the electrode plate ensures that the flowing electrolyte or the fluid also experiences a movement component normal to the plane that is defined by the base plane. These flow components away from the base plane—or towards the base plane—are generated, among other things, by the fact that successive rows of linear embossed strips in the flow direction are constructed alternately from embossed strips which are positioned in a first row at a uniform angle with respect to the longitudinal direction of the active field and inclined in the following row with the opposite orientation and the same angle in magnitude, with the already mentioned flank angles, which there are for every linear embossed strip and also for the punctiform and any other embossed elements, also playing a role.

### BRIEF DESCRIPTION OF THE DRAWINGS

Several exemplary embodiments of the disclosure are explained in more detail below by means of drawings. In the drawings:

FIG. 1 shows a first exemplary embodiment of an electrode plate for an electrolysis system in plan view;

FIG. 2 shows a second exemplary embodiment of an electrode plate for an electrolysis system in a view analogous to FIG. 1;

FIG. 3 shows a detail of an embossed structure of an electrode plate in plan view;

FIGS. 4 and 5 show the embossed structure in sectional views;

FIG. 6 shows a further plan view of the embossed structure with schematic marking of the section lines (with respect to FIGS. 4 and 5);

FIG. 7 shows a perspective view of an electrode plate with V-shaped embossed elements on the longitudinal sides of the active field;

FIG. 8 shows a perspective, rear view of an electrode plate with greatly shortened embossed strips in the inlet and outlet region of the active field;

FIG. 9 shows the electrode plate according to FIG. 7 in schematic view analogous to FIG. 6;

FIG. 10 shows the electrode plate according to FIG. 8 in schematic view analogous to FIG. 9.

### DETAILED DESCRIPTION

Unless otherwise stated, the following explanations relate to all exemplary embodiments. Parts which correspond to each other or which have basically the same effect are identified with the same reference sign in all the figures.

An electrode plate, marked overall with the reference sign 1, is made of sheet steel and is intended for use in an electrolysis system (not shown further) for hydrogen production, also referred to as the electrolysis system 10 for short. With regard to the basic structure and function of such electrolysis systems, reference is made to the prior art cited at the outset.

The electrode plate 1 is formed from sheet metal and has a rectangular, non-square shape, with a planar frame region 2 surrounding a three-dimensionally structured active surface 3. In the frame region 2 there are a plurality of openings 4, 5 of different sizes, which are circular in the exemplary embodiment, and which can be used, among other things, for the passage of media or for inserting tie rods to hold a stack of electrolysis cells together. The metal sheet is present in the frame region 2 in a manner undeformed in a flat plate shape. The undeformed, flat metal sheet forms a base plane E (see FIG. 5), from which the embossed structures 6 are formed upwards and downwards from the base plane E.

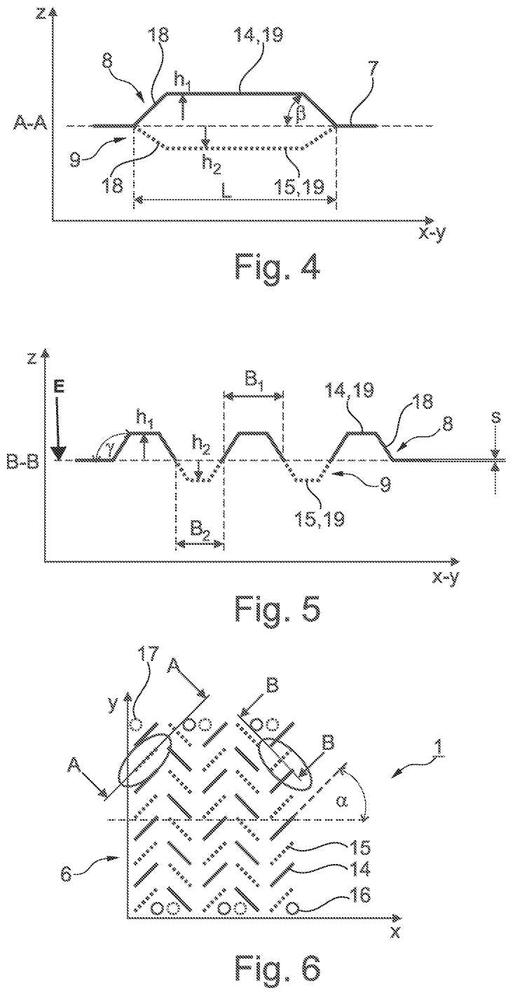

In the active surface 3 there is an embossed structure 6 which protrudes from the base plane E of the electrode plate 1 on both sides. On a first side 7 of the metal sheet, the embossed structure 6 is referred to as a raised embossed region 8 (cf. FIG. 4), which rises from the base plane E towards the viewer. The raised embossed regions 8 alternate with recessed embossed regions 9, which also rise from the base plane E, but away from the viewer.

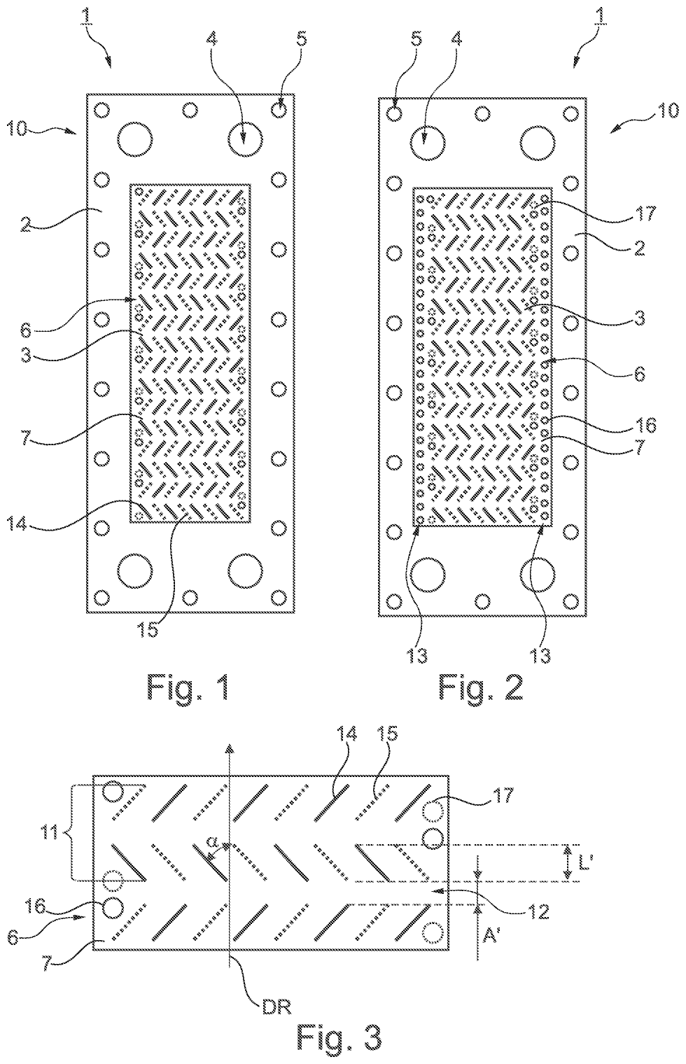

The embossed structure 6 is divided in the form of sub-clusters 11, as can be seen in particular from FIG. 3, which relates both to the exemplary embodiment according to FIG. 1 and to the exemplary embodiment according to FIG. 2. Overall, the embossed structure 6 has a row-column pattern, with each sub-cluster 11 comprising two rows of linear embossed strips 14, 15.

When operating the electrolysis system 10, the flow direction of the electrolyte, denoted by DR, corresponds to the longitudinal direction of the active field 3 and of the entire electrode plate 1. The individual embossed strips 14, 15 are inclined by a uniform angle α of 45°±15° relative to the flow direction DR. The full length of each embossed strip 14, 15 is denoted by L, and the length projected transverse to the flow direction DR, i.e. the optically shortened length, is denoted by L′. The distance, which is denoted by A′, between two sub-clusters 11 is to be measured in the flow direction DR, like the length L′, and is 5% to 10% of the projected length L′. The lengths L, L′ are also referred to as the lamella length or projected lamella length.

In addition to the linear embossed strips 14, 15, that is to say lamella, embossed points 16, 17 in the form of raised points 16 and recessed points 17 starting from the base plane E are also formed in the active surface 3 in the embodiments according to FIGS. 1 and 2. In summary, the linear embossed strips 14, 15 and embossed points 16, 17 are also referred to as embossed elements.

In all the figures, the embossed elements 14, 16 to be attributed to the raised embossed region 8 are identified by solid lines and the recessed embossed elements 15, 17 by dashed lines. At the beginning and end of each row, which is formed by linear embossed strips 14, 15 inclined in the same direction, in the cases of FIGS. 1 and 2 there is an embossed point 16, 17.

Including these optional embossed points 16, 17, raised embossed elements 14, 16 and recessed embossed elements 15, 17 are arranged alternately in each row. In principally the same way, a raised linear embossed strip 14 and a recessed linear embossed strip 15 always alternate in the columns that are formed by the linear embossed strips 14, 15 and extend in the longitudinal direction of the electrode plate 1, so that in all cases there is in total one arrangement of the embossed strips 14, 15 in a herringbone pattern. There is preferably a number of sub-clusters 11 of at least 2, in particular more than 5.

In contrast to the exemplary embodiment according to FIG. 1, in the exemplary embodiment according to FIG. 2 there is a row of raised embossed points 16 on each of the two longitudinal sides of the active field 3. These rows are also referred to as edge clusters 13 of the embossed structure 6. Deviating from the configuration outlined in FIG. 2, a first edge cluster 13 of alternatingly raised embossed points 16 and recessed embossed points 17, starting from the base plane E, could also be formed. In any case, the embossed points 16, 17 from which the edge clusters 13 are built up, which can be attributed either completely to the raised embossed region 8 or completely to the recessed embossed region 9, are linearly lined up next to those embossed points 16, 17 which, in the already described manner, mark the beginning and the end of each row on linear embossed strips 14, 15.

As can be seen from the sectional views A-A and B-B (cf. FIG. 6) in FIGS. 4 and 5, which relate to all other figures, the embossed depth, denoted by h₁, of the raised embossed region 8, i.e. the height of the embossed elements 14, 16, differs significantly, namely by more than the sheet thickness, denoted by s, of the electrode plate 1, from the embossed depth, denoted by h₂, of the recessed embossed region 9. In the present cases, the first side 7 of the electrode plate 1 lies in the x-y plane. The embossed elements 14, 15, 16, 17 extend in the z-direction. The flanks denoted by 18 at the two ends of each embossed strip 15, 16 are positioned obliquely at an angle β of 45°±15° with respect to the x-y plane.

In FIG. 5, which shows a section B-B transverse to the extension of the embossed strip 15, 16 (cf. FIG. 6), the structure width in the raised embossed region 8 is indicated with B₁ and the structure width in the recessed embossed region 9 is indicated with B₂. Furthermore, an angle γ is shown in FIG. 5, wherein the inclination of the flanks 18 on the longitudinal sides of the embossed strip 15, 16 in this case corresponds to the difference between 180° and the angle γ, and like the angle β lies in the range of 30° to 60°.

A trapezoidal profile of the linear embossed strips 14, 15 can be seen in both FIGS. 4 and 5. Plateaus of the linear embossed strips 14, 15 which lie in planes parallel to the first side 7 and are spaced apart from it by h₁ or h₂ are denoted by 19 in FIG. 5. Deviating from the idealized representations according to FIGS. 4 and 5, the transitions between the plateaus 19 and the flanks 18 as well as the transitions between the flanks 18 and the first side 7 can be rounded. All embossed elements 14, 15, 16, 17 are produced by forming methods. The application of coatings to the active surface 3 is possible before and/or after the forming.

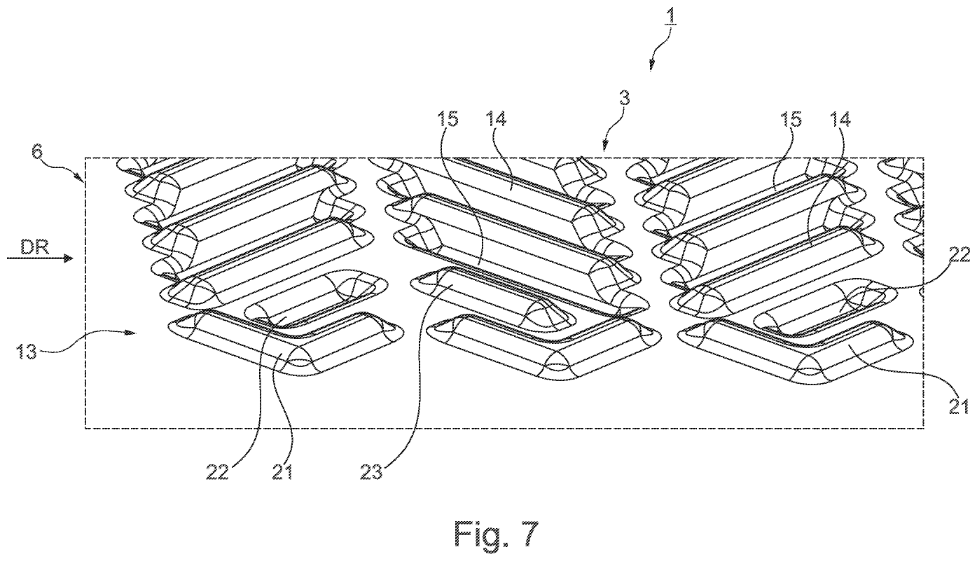

As far as the profile of the linear embossed strips 14, 15 is concerned, there are no differences between the embodiment according to FIGS. 4 and 5 and the exemplary embodiments according to FIGS. 7 to 10.

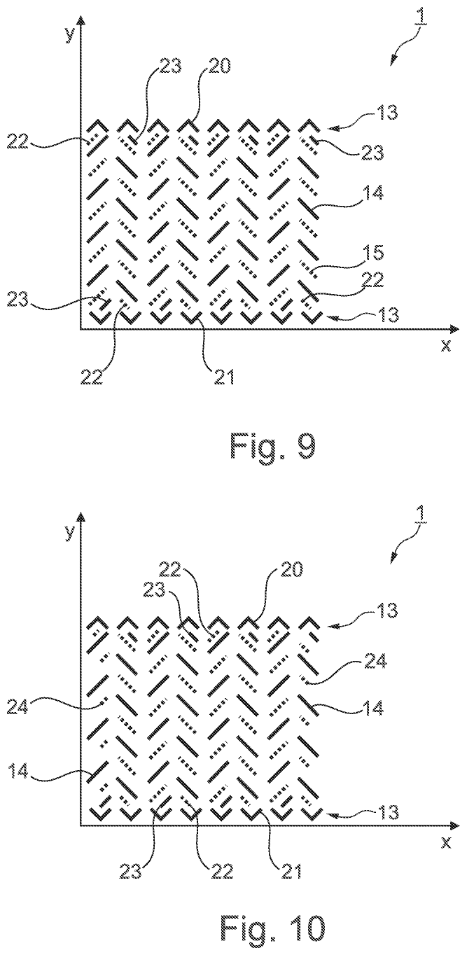

In the embodiment according to FIGS. 7 and 9, the edge clusters 13 are given by V-shaped embossed elements 20, 21. Here, the embossed element 20 appears as a typographic “open angle bracket” symbol and the embossed element 20 as a typographic “closed angle bracket” symbol at the beginning and end of each row on inclined linear embossed strips 14, 15. The flow direction DR corresponds to the x-direction in FIG. 9, as in FIG. 6. As can be seen from FIG. 7, in the side regions of the active field 3, directly next to the V-shaped embossed elements 20, 21, there are shortened, recessed or raised embossed strips 22, 23 compared to the embossed strips 14, 15. The length of these shortened embossed strips 22, 23 is more than half of the full length L of the remaining embossed strips 14, 15.

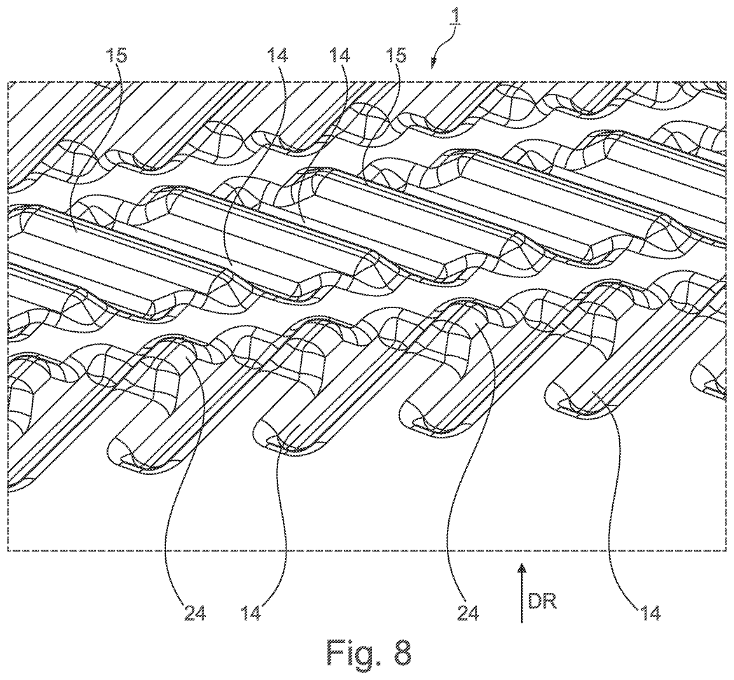

In addition to the modified side regions of the embossed structure 6, there are also modifications in the inlet region and in the outlet region of the active field 3 in the exemplary embodiment according to FIGS. 8 and 10. In contrast to FIGS. 1 and 2 as well as to FIG. 7, FIG. 8 shows the side of the electrode plate 1 arbitrarily referred to as the “rear side”. In FIG. 10, as in FIGS. 6 and 9, the “front side” of the electrode plate 1 is shown in a symbolized manner. As can be seen from FIG. 8, a greatly shortened, recessed linear embossed strip 24 is arranged in the inlet region of the active field 3 in each case between two raised linear embossed strips 14. The length of the shortened linear embossed strips 24 is less than half the otherwise uniform length L of the linear embossed strips 14, 15. This creates space at the edge of the embossed structure 6 in which a flat contact can be made between a component (not shown) and the first side 7 of the electrode plate 1, with an overlap between the unshortened linear embossed strips 14 and the component mentioned. The same applies to the outlet region of the electrolyte which, in relation to the arrangement according to FIG. 1, is disposed on the right-hand edge of the detail of the electrode plate 1 shown. In the case of FIGS. 8 and 10, all four edge regions of the overall rectangular embossed structure 6 are modified in comparison with the central region of the embossed structure 6, which is formed exclusively from the linear embossed strips 14 15.

### LIST OF REFERENCE SIGNS

1 Electrode plate
2 Frame region
3 Active field
4 Opening (large) in the frame region
5 Opening (small) in the frame region
6 Embossed structure
7 First side of the metal sheet
8 Raised embossed region (starting from the base plane)
9 Recessed embossed region (starting from the base plane)
10 Electrolysis system
11 Sub-cluster
12 Free space between two sub-clusters
13 Edge cluster
14 Raised linear embossed strip (starting from the base plane)
15 Recessed linear embossed strip (starting from the base plane)
16 Raised embossed point (starting from the base plane)
17 Recessed embossed point (starting from the base plane)
18 Flank of an embossed element
19 Plateau of an embossed element
20 V-shaped embossed element
21 V-shaped embossed element
22 Shortened, recessed embossed strip in the side region
23 Shortened raised embossed strip in the side region
24 Greatly shortened embossed strip in the inlet or outlet region
α, β, γ Angle
A′ Distance between sub-clusters
B₁ Structure width in the raised embossed region
B₂ Structure width in the recessed embossed region
DR Flow direction
h₁ Height of the raised embossed region
h₂ Height of the recessed embossed region
L Lamella length
L′ Lamella length (projected) in flow direction
s Sheet thickness
E Base plane

1. An electrode plate for an electrolysis system made of sheet metal, with a frame region which surrounds an active field and which, like the active field, has a rectangular basic shape and wherein the frame region is designed in a base plane (E) of the undeformed metal sheet, wherein the active field has an embossed structure in the form of individual embossed elements that are raised and recessed starting from the base plane (E), including a plurality of linear embossed strips, which are positioned in an arrangement of rows and columns in such a manner that raised linear embossed strips and recessed linear embossed strips are formed in an alternating manner both in the direction of the rows and the direction of the columns, wherein all linear embossed strips of a row are inclined in an identical manner relative to the longitudinal sides of the active field and a flow direction (DR) parallel thereto and the linear embossed strips of the next line have the equal and opposite inclination.

2. The electrode plate according to claim 1, wherein a sub-cluster of the embossed structure is formed by two rows of linear embossed strips, wherein in total at least four such sub-clusters are connected in series and at least three raised linear embossed strips and at least three recessed linear embossed strips are arranged in each row.

3. The electrode plate according to claim 2, wherein the distance (A′) between two sub-clusters corresponds to at least one twentieth and at most one tenth of the projected length (L′) to be measured in the longitudinal direction of the linear embossed strips arranged in a row.

4. The electrode plate according to claim 1, wherein, in the first and last row of the embossed structure, the raised linear embossed strips have the full length (L), which is also the case for the linear embossed strips of the remaining rows and alternate with shortened linear embossed strips, wherein the shortening of these linear embossed strips is in the inlet and outlet region of the active field towards the edge of the embossed structure.

5. The electrode plate according to claim 1, wherein the height (h₁) of the raised linear embossed strips differs from the height (h₂) of the recessed linear embossed strips starting from the base plane (E) by more than the sheet thickness (s) of the electrode plate.

6. The electrode plate according to claim 1, wherein the linear embossed strips are inclined at an angle (α) of 45°±15° with respect to the flow direction (DR) and are contoured in a trapezoidal manner both in the longitudinal direction and in the transverse direction of the linear embossed strips, wherein flanks of the linear embossed strips are inclined at an angle (β; 180°−γ) of 45°±15° relative to a first side of the electrode plate.

7. The electrode plate according to claim 1, wherein two rows of embossed elements which flank the arrangement of all linear embossed strips in the direction of the columns, border the frame region and have a uniform embossed direction.

8. The electrode plate according to claim, wherein the embossed elements bordering the frame region are designed as embossed points.

9. The electrode plate according to claim, wherein the embossed elements bordering the frame region each describe a V-shape, wherein each row of inclined linear embossed strips is enclosed by two V-shaped embossed elements in the manner of an open angle bracket symbol and a closed angle bracket symbol.

10. A method for producing an electrode plate from a metal sheet according to claim 1, wherein a plurality of individual embossed elements are produced by forming, which on both sides of the electrode plate protrude different distances beyond the base plane (E) and together describe a herringbone pattern of linear embossed strips on each side of the electrode plate.

11. An electrode plate comprising:
an active field;
a framed region surrounding the active field, wherein the framed region is formed in a base plane, wherein the framed region includes a plurality of openings;
an embossed structure comprising a plurality of linear embossed strips formed within the active field, wherein at least some of the linear embossed strips are raised from the base plane and at least some of the linear embossed strips are recessed into the base plane; and
wherein the linear embossed strips of a first row are inclined relative to a longitudinal side of the active field at a first angle and the linear embossed strips of a second row are inclined relative to the longitudinal side of the active field at a second angle equal to and opposite to the first angle.

12. The electrode plate of claim 11, wherein at least some of the embossed elements bordering the frame region comprise embossed points.

13. The electrolysis system of claim 11, wherein at least some of the linear embossed strips have a trapezoidal profile.

14. The electrode plate of claim 11, wherein a sub-cluster of the embossed structure is formed by two rows of linear embossed strips, wherein in total at least four sub-clusters are connected in series and at least three raised linear embossed strips and at least three recessed linear embossed strips are arranged in each row.

15. The electrode plate of claim 12, wherein a height (h₁) of the raised linear embossed strips differs from the height (h₂) of the recessed linear embossed strips starting from the base plane by more than the sheet thickness of the electrode plate.

16. An electrolysis system for hydrogen production comprising:
an electrode plate formed from a metal, wherein the electrode plate comprises:
an active field;
a frame region surrounding the active field and wherein the frame region is formed in a base plane, wherein the frame region includes a plurality of openings;
an embossed structure comprising a plurality of embossed elements comprising a plurality of linear embossed strips formed within the active field, wherein at least some of the linear embossed strips are raised from the base plane and at least some of the linear embossed strips are recessed into the base plane;
wherein the linear embossed strips of a first row are inclined relative to a longitudinal side of the active field at a first angle and the linear embossed strips of a second row are inclined relative to the longitudinal side of the active field at a second angle equal to and opposite to the first angle; and
wherein the electrolysis system, during operation, flows an electrolyte along a longitudinal direction of the active field of the electrode plate.

17. The electrode plate of claim 12, wherein at least some of the embossed elements bordering the frame region comprise embossed points.

18. The electrolysis system of claim 12, wherein at least some of the linear embossed strips have a trapezoidal profile.

19. The electrode plate of claim 11, wherein a sub-cluster of the embossed structure is formed by two rows of linear embossed strips, wherein in total at least four sub-clusters are connected in series and at least three raised linear embossed strips and at least three recessed linear embossed strips are arranged in each row.

20. The electrode plate of claim 12, wherein a height (h₁) of the raised linear embossed strips differs from the height (h₂) of the recessed linear embossed strips starting from the base plane by more than the sheet thickness of the electrode plate.
